(19) United States
(12) Patent Application Publication
(10) Pub. No.: US 2006/0059951 A1
(43) Pub. Date: Mar. 23, 2006

(54) System for producing upper plates of flat fluorescent lamps

(75) Inventor: Jae Doo Yoon, Gyunggi-Do (KR)

Correspondence Address: FLESHNER & KIM, LLP, P.O. BOX 221200, CHANTILLY, VA, 20153, US

(73) Assignee: Mirae Corporation

(21) Appl. No.: 11/037,240

(22) Filed: Jan. 19, 2005

(30) Foreign Application Priority Data
Sep. 21, 2004 (KR) 2004-75386

(51) Int. Cl. C03B 23/035

(52) U.S. Cl. 65/138; 65/273; 65/268; 65/140

(57) ABSTRACT

A system for producing upper plates of flat fluorescent lamps (FFL upper plates) is disclosed. In the system, various units used for producing the FFL upper plates are placed on or around multi-storied conveyors of a conveying unit, so that the area and space required to situate the various units is minimized. The system also allows an FFL upper plate producing process, including glass panel feeding, glass panel heating, glass panel shaping to provide an FFL upper plate, FFL upper plate heat-treatment, and FFL upper plate discharge, to be executed quickly and continuously in real time, thus maximizing work efficiency and productivity when producing the FFL upper plates. The system includes a conveying unit having a plurality of conveyors placed to form a multi-storied conveyor structure, first and second transfer units placed at opposite ends of the conveying unit, a glass panel feed unit to feed glass panels onto the conveying unit, a heating unit to further heat the glass panels on the conveying unit, a shaping unit to shape the heated glass panels, thus providing FFL upper plates, a heat treatment unit to slowly cool the FFL upper plates, and a product discharge unit to discharge the FFL upper plates from the conveying unit to the outside of the system.

### BACKGROUND OF THE INVENTION

1. Field of the Invention

The present invention relates, in general, to systems for producing the upper plates of flat fluorescent lamps used as backlight units in display devices, such as LCDS, and, more particularly, to a system for producing the upper plates of the flat fluorescent lamps (FFL upper plates), in which various units used for producing the FFL upper plates are placed on or around multi-storied conveyors of a conveying unit, so that the area and space required to situate the various units is minimized, and which allows an FFL upper plate producing process, comprising glass panel feeding, glass panel heating, glass panel shaping to provide an FFL upper plate, FFL upper plate heat-treatment, and FFL upper plate discharge to be executed quickly and continuously in real time, thus maximizing work efficiency and productivity when producing the FFL upper plates.

2. Description of the Related Art

Generally, a flat fluorescent lamp (FFL) comprises a channeled upper plate L and a flat lower plate L′ which are closely integrated into a sealed single lamp body as shown in FIGS. 1 and 2, and is used as a backlight unit (BLU) in display devices, such as LCD panels. The FFL must be configured such that the FFL maintains high brightness constantly over its whole area without any variation in brightness between zones.

In an effort to allow the FFL to provide high brightness and maintain the high brightness constantly over its whole area, the FFL upper plate L must be carefully produced. As shown in FIGS. 1 and 2, the FFL upper plate L is configured such that a channel C having a serpentine shape covers on the entire area of the upper plate L. When the upper plate L is integrated with the flat lower plate L′ to form an FFL, the serpentine channel C forms a plasma discharge space D in the FFL.

To produce the FFL upper plate L, a flat glass panel having a standard size is softened by heat, and, thereafter, the softened glass panel is processed using a press mold comprising a cavity having a predetermined shape corresponding to a designed shape of the FFL upper plate L. Thus, a conventional system for producing FFL upper plates comprises a conveyor unit to feed glass panels, a heating unit to heat and soften the glass panels fed by the conveyor unit, and a press unit to press the thermally softened glass panels, thus providing desired FFL upper plates.

However, in the conventional system for producing the FFL upper plates, the conveyor unit to feed glass panels, the heating unit to thermally soften the glass panels, and the press unit to shape the FFL upper plates by pressing the thermally softened glass panels are independently and separately situated, so that the FFL upper plates cannot be produced quickly and continuously in real time, but are produced while being conveyed between stages having the units spaced apart from each other by substantial distances. Thus, the conventional system for producing the FFL upper plates is problematic in that it reduces the productivity of manufacturing the FFL upper plates, and requires excessive area and space for separately and independently placing the units for feeding, heating and pressing the glass panels, thus having inferior spatial efficiency.

Furthermore, the conventional system for producing the FFL upper plates executes the FFL upper plate producing process, comprising glass panel feeding, glass panel heating and glass panel pressing to shape an FFL upper plate, while conveying the glass panel between stages, thus losing heat from the heated glass panel. Due to the heat loss from the glass panel, the press unit may fail to efficiently press the glass panel so that the conventional system may not produce desirably shaped FFL upper plates. Furthermore, the glass panel or a shaped product that is an FFL upper plate may be easily damaged or broken when the glass panel or the FFL upper plate is conveyed between the stages.

Furthermore, the conventional system for producing the FFL upper plates does not have a cooling means for appropriately cooling the shaped products that are the FFL upper plates provided by pressing the heated glass panels using the press unit. Thus, the shaped products in the conventional system have been cooled in air or in water. However, the air-cooling method or the water-cooling method is a quick cooling method which may cause the products that are the FFL upper plates made of glass to be thermally shocked and cracked, or thermally deformed due to the intrinsic properties of glass.

### SUMMARY OF THE INVENTION

Accordingly, the present invention has been made keeping in mind the above problems occurring in the related art, and an object of the present invention is to provide a system for producing upper plates of flat fluorescent lamps (FFL), in which a plurality of conveyors to convey glass panels and FFL upper plates are placed to form a conveyor unit having a multi-storied conveyor structure, thus minimizing the area and space required to place various units of the system, and which allows an FFL upper plate producing process, comprising glass panel feeding, glass panel heating, glass panel shaping to provide an FFL upper plate, FFL upper plate heat-treatment, and FFL upper plate discharge, to be executed quickly and continuously in real time, thus maximizing work efficiency and productivity when producing the FFL upper plates, and which minimizes heat loss during a period from the step of heating a glass panel to the step of shaping the heated glass panel to provide a desired FFL upper plate, and which slowly cools the shaped FFL upper plates rather than quickly cooling them, thus minimizing thermal shock which may be applied to the FFL upper plates.

In order to achieve the above object, according to an embodiment of the present invention, there is provided a system for producing upper plates of flat fluorescent lamps, comprising: a conveying unit, comprising a plurality of conveyors having identical length placed in the conveyor unit such that the conveyors form a multi-storied conveyor structure and convey glass panels and upper plates of flat fluorescent lamps (FFL upper plates); a first transfer unit placed at a first end of the conveying unit, and transferring the glass panels from a lower conveyor onto an upper conveyor of the conveying unit; a second transfer unit placed at a second end of the conveying unit, and transferring the FFL upper plates from the upper conveyor onto the lower conveyor of the conveying unit; a glass panel feed unit placed at a predetermined position around the conveying unit, and feeding glass panels onto the conveying unit; a heating unit provided over a predetermined portion of the conveying unit to heat the glass panels, thus thermally softening the glass panels so that the glass panels may be shaped; a shaping unit placed on the conveying unit at a predetermined position to shape the thermally softened glass panels, thus providing the FFL upper plates; a heat treatment unit provided over a predetermined portion of the conveying unit to cool the FFL upper plates while preventing the FFL upper plates from being quickly cooled; and a product discharge unit placed at a predetermined position around the conveying unit, and discharging products that are the FFL upper plates from the conveying unit to an outside of the system after the FFL upper plates have been heat-treated by the heat treatment unit.

The first transfer unit may comprise: an up-transfer lift to transfer the glass panels from the lower conveyor onto the upper conveyor of the conveying unit, the up-transfer lift being operated by an actuating unit and comprising: a glass panel seat to seat a glass panel thereon; a push guide provided at a side of the glass panel seat to push the glass panel out of the glass panel seat; and a drive unit placed on a support stand and coupled to the push guide, thus operating the push guide. The second transfer unit may comprises: a down-transfer lift to transfer the FFL upper plates from the upper conveyor onto the lower conveyor of the conveying unit, the down-transfer lift being operated by an actuating unit and comprising: an FFL upper plate seat to seat an FFL upper plate thereon; a push guide provided at a side of the FFL upper plate seat to push the FFL upper plate out of the FFL upper plate seat; and a drive unit placed on a support stand and coupled to the push guide, thus operating the push guide.

The glass panel feed unit may comprise: a preheater to preheat the glass panels; and a feed arm to feed each of the preheated glass panels from the preheater onto the lower conveyor of the conveying unit. The heating unit may comprise: a heater to heat the glass panels fed onto the conveying unit by the glass panel feed unit, so that the glass panels are thermally softened enough to be shaped. The shaping unit may comprise: an upper mold and a lower mold to shape the thermally softened glass panels, thus providing the FFL upper plates, either the upper mold or the lower mold being provided with a depressed pattern to form a shaping cavity corresponding to a shape of the FFL upper plates. The heat treatment unit may comprise: an air spraying unit to spray preheated air having a predetermined temperature onto the FFL upper plates which have been shaped by the shaping unit. The product discharge unit may comprise: a discharge arm to discharge each of the FFL upper plates from the conveying unit to the outside of the system after the FFL upper plates have been processed by the heat treatment unit.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a plan view illustrating the construction of a conventional flat fluorescent lamp (FFL);

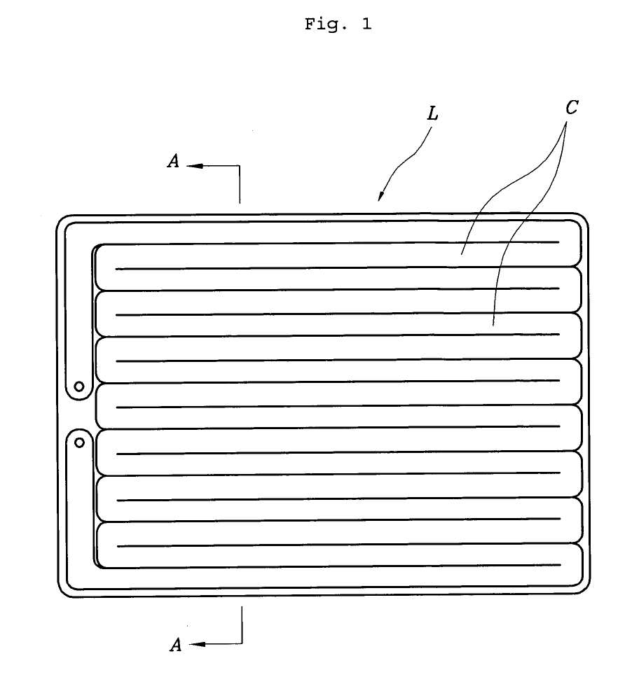

FIG. 2 is a sectional view of the conventional FFL taken along the line A-A of FIG. 1;

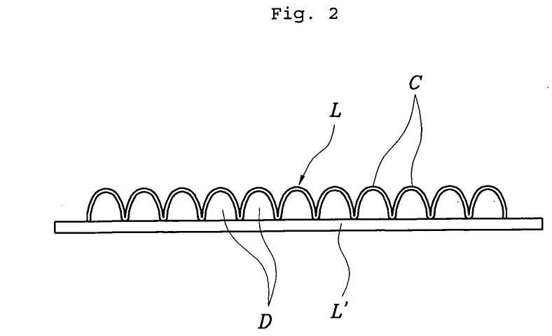

FIG. 3 is a front view illustrating the construction of a system for producing FFL upper plates according to the present invention;

FIG. 4 is a plan view illustrating the construction and operation of a conveying unit of the system, according to a first embodiment of the present invention;

FIG. 5 is a plan view illustrating the construction and operation of a conveying unit of the system, according to a second embodiment of the present invention;

FIG. 6 is a sectional view taken along the line A-A of FIG. 3, which illustrates both a glass panel feed unit and an FFL upper plate discharge unit of the system according to the present invention;

FIG. 7 is a sectional view taken along the line B-B of FIG. 3, which illustrates a heating unit of the system according to the present invention;

FIG. 8 is a sectional view taken along the line C-C of FIG. 3, which illustrates a first transfer unit of the system according to the present invention;

FIG. 9 is a sectional view taken along the line D-D of FIG. 3, which illustrates a shaping unit of the system according to the present invention;

FIGS. 10 and 11 are sectional views illustrating molds of the shaping unit of FIG. 9;

FIG. 12 is a sectional view taken along the line E-E of FIG. 3, which illustrates a heat treatment unit of the system according to the present invention; and

FIG. 13 is a sectional view taken along the line F-F of FIG. 3, which illustrates a second transfer unit of the system according to the present invention.

### DETAILED DESCRIPTION OF THE INVENTION

Reference will now be made in greater detail to a preferred embodiment of the invention, an example of which is illustrated in the accompanying drawings. Wherever possible, the same reference numerals will be used throughout the drawings and the description to refer to the same or like parts.

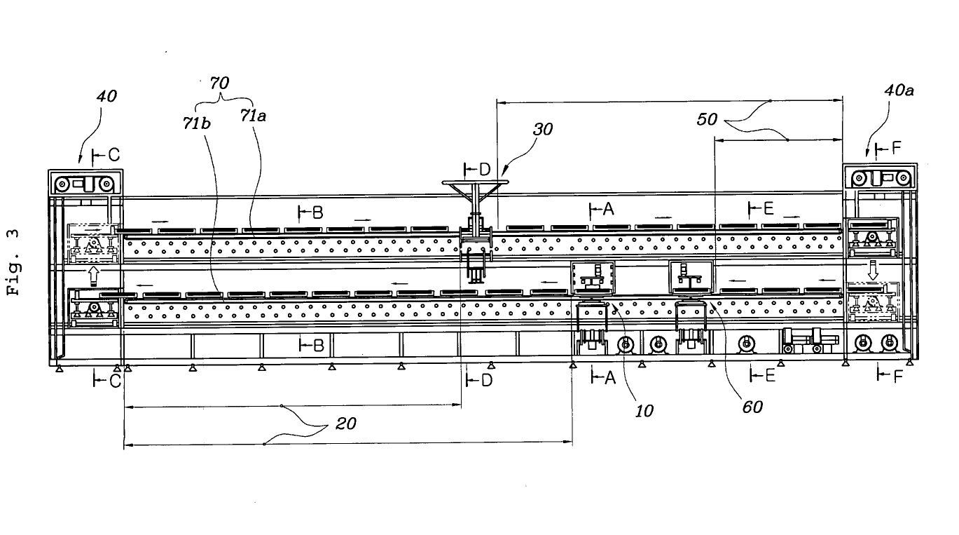

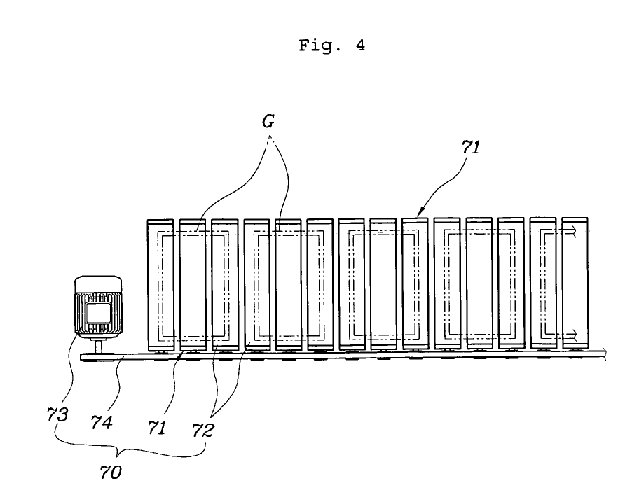

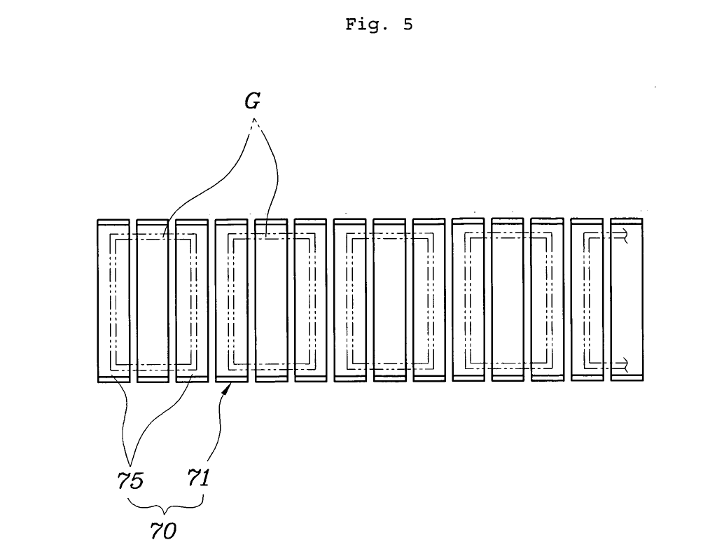

FIG. 3 is a front view illustrating the construction of a system for producing FFL upper plates according to the present invention. As shown in the drawing, the system according to the present invention comprises a conveying unit 70 for conveying glass panels G and FFL upper plates L in desired directions in real time. The conveying unit 70 is configured such that a plurality of conveyors 71 having identical length is placed in the conveyor unit 70 so that the conveyors 71 form a multi-storied conveyor structure comprising an upper conveyor 71a a lower conveyor 71b. The conveying unit 70 of the present invention having the multi-storied conveyor structure may be embodied differently as follows. As shown in FIG. 4, the conveying unit 70 may be configured such that a plurality of rollers 72 is arranged at regular intervals, and is coupled to a drive motor 73 through a power transmission chain 74, thus forming a multi-storied conveyor structure capable of conveying glass panels G and FFL upper plates L using the drive motor power. Alternatively, as shown in FIG. 5, the conveying unit 70 may be configured such that a plurality of idle rollers 75 is arranged at regular intervals, without using any motor, thus forming a multi-storied conveyor structure capable of conveying glass panels G and FFL upper plates L due to a pushing force transferred from the glass panels G and the FFL upper plates L which are placed on the idle rollers 75 while being in contact with each other, and are continuously pushed in a desired direction.

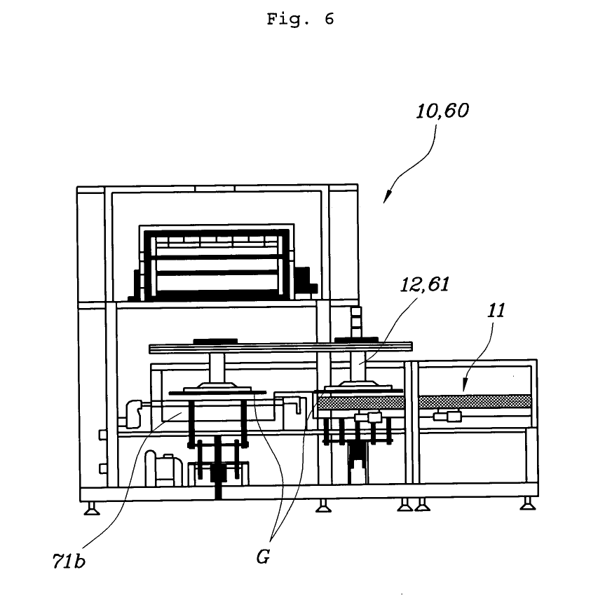

Furthermore, a glass panel feed unit 10 is placed at a predetermined position around the lower conveyor 71b of the conveying unit 70 as shown in FIG. 6, so that the glass panel feed unit 10 feeds glass panels G onto the lower conveyor 71b of the conveying unit 70. The glass panel feed unit 10 comprises a preheater 11 and a feed arm 12. The glass panels G are placed on the preheater 11 and preheated to a predetermined temperature not higher than 100° C. The feed arm 12 holds the preheated glass panels G one by one, and places the glass panels G onto the lower conveyor 71b. In the present invention, the feed arm 12 preferably holds the preheated glass panels G using a vacuum.

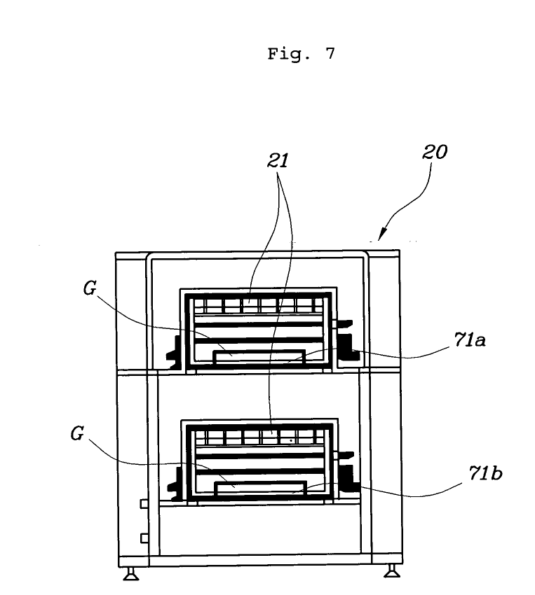

The preheated glass panels G fed onto the lower conveyor 71b are further heated such that the glass panels G are thermally softened enough to be shaped into desired FFL upper plates. Thus, a heating unit 20 is provided on the conveying unit 70 within a predetermined region from the outlet of the glass panel feed unit 10 to the inlet of a shaping unit 30 which will be described later herein. As illustrated in FIG. 7, the heating unit 20 comprises a heater 21 to heat the preheated glass panels G such that the glass panels G are thermally softened enough to be shaped into desired FFL upper plates.

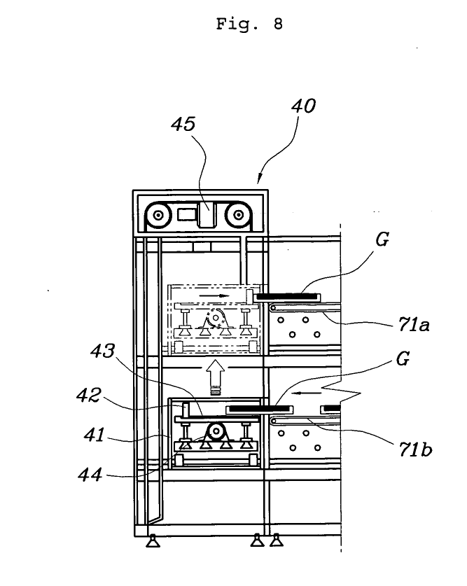

The heating unit 20 is provided within the region from part of the lower conveyor 71b to part of the upper conveyor 71a, so that the glass panels G must be transferred from the lower conveyor 71b onto the upper conveyor 71a of the conveying unit 70. Thus, to transfer the glass panels G from the lower conveyor 71b onto the upper conveyor 71a, a first transfer unit 40 is placed at a first end of the conveying unit 70 as shown in FIG. 8.

The first transfer unit 40 comprises an up-transfer lift 41 to transfer the glass panels G from the lower conveyor 71b onto the upper conveyor 71a of the conveying unit 70. To operate the up-transfer lift 41, an actuating unit 45, such as a motor or a cylinder actuator, is provided in the first transfer unit 40. The up-transfer lift 41 further comprises a glass panel seat 42 to seat a glass panel G thereon; a push guide 43 provided at a side of the glass panel seat 42 to push the glass panel G out of the glass panel seat 42; and a drive unit 44, such as a motor or a cylinder actuator, placed on a support stand and coupled to the push guide 43, thus operating the push guide 43. Thus, each glass panel G conveyed by the lower conveyor 71b is seated on the glass panel seat 42, and, thereafter, the motor or the cylinder actuator used as the actuating unit 45 is operated to move the up-transfer lift 41 having the glass panel G therein upwards.

When the up-transfer lift 41 with the glass panel G seated therein has been moved upwards to a predetermined height, the drive unit 44 of the lift 41 is operated to move the push guide 43 towards the upper conveyor 71a. Thus, the glass panel G is transferred from the glass panel seat 42 of the up-transfer lift 40 onto the upper conveyor 71a including part of the heating unit 20. Therefore, the glass panels G are further heated while the panels G are conveyed by the upper conveyor 71a.

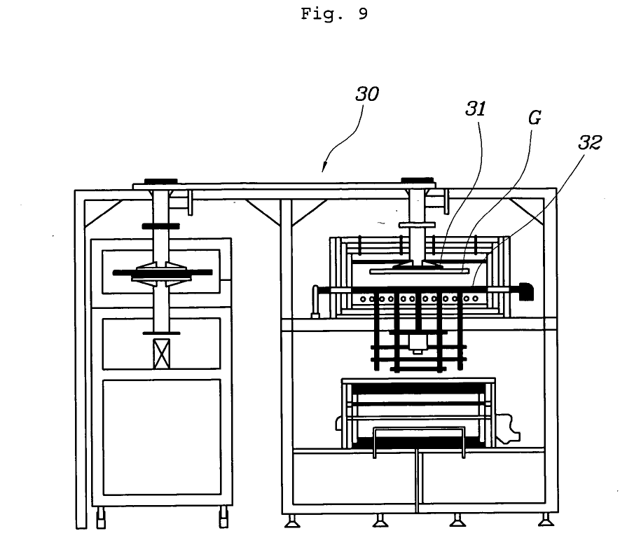

When the glass panel G has been heated to a desired temperature by the heating unit 20 while the panel G is conveyed by the upper conveyor 71a, the heated glass panel G is shaped into an FFL upper plate L having a designed shape by the shaping unit 30 which is placed on the conveying unit 70 at a predetermined position corresponding to a terminal end of the heating unit 20. As illustrated in FIGS. 9, 10 and 11, the shaping unit 30 comprises an upper mold 31 and a lower mold 32 to shape the heated glass panels G, thus providing the FFL upper plates L. Either the upper mold 31 or the lower mold 32 is provided with a depressed pattern so that, when the two molds 31 and 32 are assembled together, a shaping cavity corresponding to a designed shape of the FFL upper plates L is formed between the two molds 31 and 32.

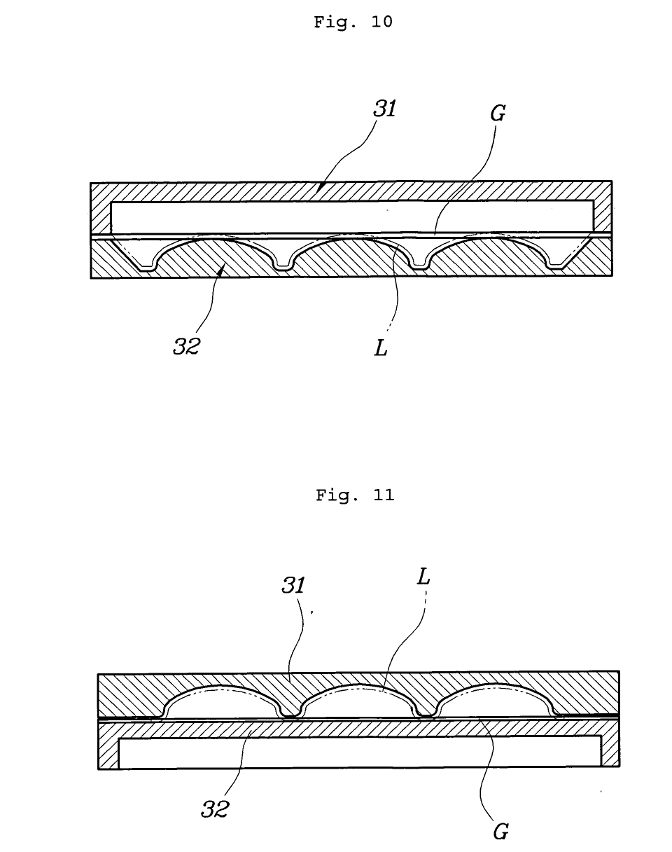

To shape a heated glass panel G using the shaping unit 30, thereby providing an FFL upper plate L having a designed shape, the heated glass panel G is placed between the upper mold 31 and the lower mold 32 of the shaping unit 30 such that the shaping cavity formed by the depressed pattern of the shaping unit 30 is sealed. Thereafter, air is drawn out of the shaping cavity until the cavity becomes vacuumized, so that the heated glass panel G is deformed according to the depressed pattern and shaped into an FFL upper plate L having the designed shape. In the present invention, the depressed pattern of the shaping unit 30 may be provided in either the lower mold 32 as shown in FIG. 10 or the upper mold 31 as shown in FIG. 11.

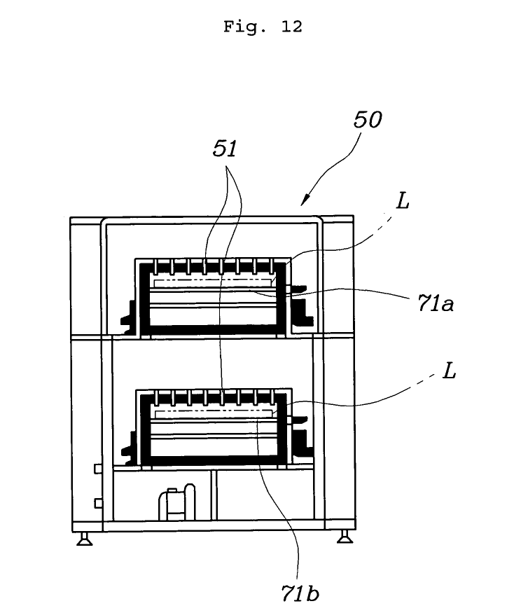

Furthermore, when the FFL upper plate L provided by the shaping unit 30 is quickly cooled, the FFL upper plate L made of glass may be thermally shocked and cracked, or thermally deformed due to intrinsic properties of glass. Thus, it is necessary to slowly cool the FFL upper plate L. To slowly cool the FFL upper plate L, a heat treatment unit 50 is provided over a predetermined portion of the conveying unit 70 from the outlet of the shaping unit 30 to the inlet of a product discharge unit 60 which will be described later herein. As illustrated in FIG. 12, the heat treatment unit 50 comprises an air spraying unit 51 to spray preheated air having a predetermined temperature onto the FFL upper plates L which have been shaped by the shaping unit 30, thus slowly cooling the FFL upper plates L while preventing the FFL upper plates L from being quickly cooled.

In the present invention, it is preferred to control the temperature of the preheated air sprayed from the air spraying unit 51 onto the FFL upper plates L, such that the temperature of the preheated air is gradually reduced in a direction from the heat treatment unit 50 to the inlet of the product discharge unit 60. Particularly, in the present invention, the temperature of the preheated air sprayed from the air spraying unit 51 onto the FFL upper plates L at a position adjacent to the inlet of the product discharge unit 60 is preferably set to about room temperature, 20˜30° C.

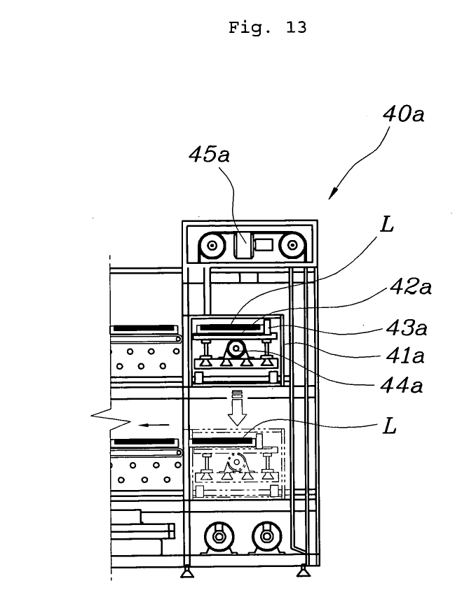

The heat treatment unit 50 to slowly cool the FFL upper plates L is provided within a region from part of the upper conveyor 71a to part of the lower conveyor 71b, so that, to desirably cool the FFL upper plates L which have been shaped by the shaping unit 30, the FFL upper plates L must be transferred from the upper conveyor 71a onto the lower conveyor 71b of the conveying unit 70. Thus, a second transfer unit 40a to transfer the FFL upper plates L from the upper conveyor 71a onto the lower conveyor 71b is placed at a second end of the conveying unit 70 as shown in FIG. 13.

The second transfer unit 40a comprises a down-transfer lift 41a to transfer the FFL upper plates L from the upper conveyor 71a onto the lower conveyor 71b of the conveying unit 70. To operate the down-transfer lift 41a, an actuating unit 45a, such as a motor or a cylinder actuator, is provided in the second transfer unit 40a. The down-transfer lift 41a further comprises an FFL upper plate seat 42a to seat an FFL upper plate L thereon; a push guide 43a provided at a side of the FFL upper plate seat 42a to push the FFL upper plate L out of the FFL upper plate seat 42a; and a drive unit 44a, such as a motor or a cylinder actuator, placed on a support stand and coupled to the push guide 43a, thus operating the push guide 43a. Thus, each FFL upper plate L conveyed by the upper conveyor 71a is seated on the FFL upper plate seat 42a, and, thereafter, the motor or the cylinder actuator used as the actuating unit 45a is operated to move the down-transfer lift 41a having the FFL upper plate L therein downwards.

When the down-transfer lift 41a with the FFL upper plate L seated therein has been moved downwards to a predetermined height, the drive unit 44a of the lift 41a is operated to move the push guide 43a towards the lower conveyor 71b. Thus, the FFL upper plate L is transferred from the FFL upper plate seat 42a of the down-transfer lift 40a onto the lower conveyor 71b including part of the heat treatment unit 50. Therefore, the FFL upper plates L are desirably cooled and heat-treated while the FFL upper plates L are conveyed by the lower conveyor 71b.

When the FFL upper plates L which are the products of the system have been cooled and heat-treated by the heat treatment unit 50, the FFL upper plates L are discharged from the conveying unit 70 to the outside of the system using the product discharge unit 60. The product discharge unit 60 is placed at a predetermined position around the lower conveyor 71b of the conveying unit 70. To discharge the FFL upper plates L from the conveying unit 70 to the outside of the system, a discharge arm 61 is provided in the product discharge unit 60. The discharge arm 61 holds the FFL upper plates L one by one using a vacuum, and discharges the FFL upper plates L to the outside. The above-mentioned construction of the product discharge unit 60 is similar to that of the glass panel feed unit 10, except for the fact that the product discharge unit 60 does not have a preheater, unlike the glass panel feed unit 10.

In the present invention, a glass carrier feed unit (not shown) is preferably provided between the product discharge unit 60 and the glass panel feed unit 10 to preheat and feed a plurality of glass carriers to the glass panel feed unit 10. The glass carrier feed unit preheats the glass carriers and feeds the preheated glass carriers to the glass panel feed unit 10, so that each glass panel G is preferably fed from the glass panel feed unit 10 onto the lower conveyor 71b while being seated in a preheated glass carrier.

Furthermore, the system for producing the FFL upper plates according to the present invention is preferably installed in a protective chamber such that the glass panels G and the FFL upper plates L as well as system are isolated and protected from atmospheric air. Particularly, both the heating unit 20 and the heat treatment unit 50 are preferably placed in a protective chamber so that heat efficiency of the two units 20 and 50 is improved.

As is apparent from the above description, the present invention provides a system for producing upper plates of flat fluorescent lamps (FFL upper plates). In the system of the present invention, a plurality of conveyors to convey glass panels and products which are FFL upper plates is placed to form a conveyor unit having a multi-storied conveyor structure, thus minimizing the area and space required to place various units of the system. The system also allows an FFL upper plate producing process, comprising glass panel feeding, glass panel heating, glass panel shaping to provide an FFL upper plate, FFL upper plate heat-treatment, and FFL upper plate discharge, to be executed quickly and continuously in real time, thus maximizing work efficiency and productivity when producing the FFL upper plates. Furthermore, the system minimizes heat loss during a period from the step of heating a glass panel to the step of shaping the heated glass panel to provide a desired FFL upper plate. Furthermore, the system slowly cools the shaped FFL upper plates rather than quickly cooling them, thus minimizing thermal shock which may be applied to the FFL upper plates.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A system for producing upper plates of flat fluorescent lamps, comprising:
a conveying unit, comprising a plurality of conveyors having identical length placed in the conveyor unit such that the conveyors form a multi-storied conveyor structure and convey glass panels and upper plates of flat fluorescent lamps (FFL upper plates);
a first transfer unit placed at a first end of the conveying unit, and transferring the glass panels from a lower conveyor onto an upper conveyor of the conveying unit;
a second transfer unit placed at a second end of the conveying unit, and transferring the FFL upper plates from the upper conveyor onto the lower conveyor of the conveying unit;
a glass panel feed unit placed at a predetermined position around the conveying unit, and feeding glass panels onto the conveying unit;
a heating unit provided over a predetermined portion of the conveying unit to heat the glass panels, thus thermally softening the glass panels so that the glass panels may be shaped;
a shaping unit placed on the conveying unit at a predetermined position to shape the thermally softened glass panels, thus providing the FFL upper plates;
a heat treatment unit provided over a predetermined portion of the conveying unit to cool the FFL upper plates while preventing the FFL upper plates from being quickly cooled; and
a product discharge unit placed at a predetermined position around the conveying unit, and discharging products that are the FFL upper plates from the conveying unit to an outside of the system after the FFL upper plates have been heat-treated by the heat treatment unit.

2. The system for producing the upper plate of the flat fluorescent lamp according to claim 1, wherein the first transfer unit comprises:
an up-transfer lift to transfer the glass panels from the lower conveyor onto the upper conveyor of the conveying unit, the up-transfer lift being operated by an actuating unit and comprising:
a glass panel seat to seat a glass panel thereon;
a push guide provided at a side of the glass panel seat to push the glass panel out of the glass panel seat; and
a drive unit placed on a support stand and coupled to the push guide, thus operating the push guide.

3. The system for producing the upper plate of the flat fluorescent lamp according to claim 1, wherein the second transfer unit comprises:
a down-transfer lift to transfer the FFL upper plates from the upper conveyor onto the lower conveyor of the conveying unit, the down-transfer lift being operated by an actuating unit and comprising:
an FFL upper plate seat to seat an FFL upper plate thereon;
a push guide provided at a side of the FFL upper plate seat to push the FFL upper plate out of the FFL upper plate seat; and
a drive unit placed on a support stand and coupled to the push guide, thus operating the push guide.

4. The system for producing the upper plate of the flat fluorescent lamp according to claim 1, wherein the glass panel feed unit comprises:
a preheater to preheat the glass panels; and
a feed arm to feed each of the preheated glass panels from the preheater onto the lower conveyor of the conveying unit.

5. The system for producing the upper plate of the flat fluorescent lamp according to claim 1, wherein the heating unit comprises:
a heater to heat the glass panels fed onto the conveying unit by the glass panel feed unit, so that the glass panels are thermally softened enough to be shaped.

6. The system for producing the upper plate of the flat fluorescent lamp according to claim 1, wherein the shaping unit comprises:
an upper mold and a lower mold to shape the thermally softened glass panels, thus providing the FFL upper plates, either the upper mold or the lower mold being provided with a depressed pattern to form a shaping cavity corresponding to a shape of the FFL upper plates.

7. The system for producing the upper plate of the flat fluorescent lamp according to claim 1, wherein the heat treatment unit comprises:
an air spraying unit to spray preheated air having a predetermined temperature onto the FFL upper plates which have been shaped by the shaping unit.

8. The system for producing the upper plate of the flat fluorescent lamp according to claim 1, wherein the product discharge unit comprises:
a discharge arm to discharge each of the FFL upper plates from the conveying unit to the outside of the system after the FFL upper plates have been processed by the heat treatment unit.
